(19) United States
(12) Patent Application Publication
(10) Pub. No.: US 2019/0191415 A1
(43) Pub. Date: Jun. 20, 2019

(54) METHOD, DEVICE, AND SYSTEM FOR MANAGING PORTAL SERVER

(71) Applicant: NEC CORPORATION, Tokyo (JP)

(72) Inventor: Takehiro SUZUKI, Tokyo (JP)

(73) Assignee: NEC CORPORATION, Tokyo (JP)

(21) Appl. No.: 16/327,462

(22) PCT Filed: Aug. 7, 2017
(86) PCT No.: PCT/JP2017/028532

§ 371 Date: Feb. 22, 2019

(30) Foreign Application Priority Data
Aug. 23, 2016 (JP) 2016-162517

(51) Int. Cl. H04W 72/04; H04L 29/08; H04W 68/00

(52) U.S. Cl. CPC H04W 72/04; H04W 68/005; H04L 67/02

(57) ABSTRACT

A management device for managing a portal server includes a detection unit that detects subscriber identification information of a subscriber terminal from an access request received from the subscriber terminal, and a control unit that allocates an accommodation destination of the access request to one of a plurality of portal servers, based on the subscriber identification information.

### TECHNICAL FIELD

One aspect of the present invention relates to a technology for managing a portal server that receives access from a subscriber terminal.

### BACKGROUND ART

A portal site is an entrance of Web use in a current Internet environment, and various services and information are aggregated and presented on a Web screen in such a way that a user may easily access a service providing server. A subscriber normally accesses a portal server by using setting information such as a uniform resource locator (URL) of an access destination previously distributed from a communication carrier and a subscriber identification number. Therefore, it may be said that the subscriber is fixed to the portal server designated by the communication carrier. Service providing systems and portal servers that have been proposed are examples of various responses based on this architecture. For example, PTL 1 proposes a system for facilitating acquisition of package software by performing user authentication in a portal server and redirecting a user to a desired software providing server.

### CITATION LIST

### Patent Literature

[PTL 1] Japanese Unexamined Patent Application Publication No. 2014-026597

### SUMMARY OF INVENTION

### Technical Problem

However, when the number of subscribers increases and is likely to exceed a maximum accommodation number of portal servers, a communication carrier needs to handle the increase in subscribers by adding a portal server. In this case, a plurality of portal servers have different URLs, and thus the communication carrier needs to notify a subscriber that an access destination is changed every time a portal server is added or every time a portal server is changed to a different portal server. The subscriber needs to change an access destination to a portal server to which the subscriber belongs according to the notification. A setting change occurring due to such a circumstance on the system side is a great burden on the subscriber.

Further, when a communication carrier performs a maintenance operation for each subscriber in a system including a plurality of portal servers, searching needs to be performed on all the portal servers with a subscriber identification number as a key. Thus, a searching load increases as the number of portal servers increases, and a new problem that speeding-up of a maintenance operation for each subscriber becomes difficult occurs.

Furthermore, network function virtualization that achieves network functions such as a broadband remote access server (BRAS), a router, and a firewall on a general-purpose server is a significant shift in a carrier network. The network function virtualization is also highly expected because the network function virtualization facilitates adding a network function, upgrading throughput capacity, and the like, and may easily handle an increase in the number of subscribers.

However, as described above, a fixed relationship between a subscriber and a portal server greatly impairs advantages of virtualization in that a load is distributed among a plurality of portal servers and a subscriber is moved to another portal server. Such a reduction in flexibility in an aspect of operation is also a great problem that needs to be solved.

Thus, an object of one aspect of the present invention is to provide a method, a device, and a system for managing a portal server that may achieve an increase in the number of portal servers without a burden on a subscriber while maintaining flexibility in an aspect of network operation.

### Solution to Problem

A management device for managing a portal server according to one aspect of the present invention includes detection means for detecting subscriber identification information of a subscriber terminal from an access request received from the subscriber terminal; and control means for allocating an accommodation destination of the access request to one of a plurality of portal servers, based on the subscriber identification information.

A management method for managing a portal server according to one aspect of the present invention includes:

detecting, by detection means, subscriber identification information of a subscriber terminal from an access request received from the subscriber terminal; and

allocating, by control means, an accommodation destination of the access request to one of a plurality of portal servers, based on the subscriber identification information.

A management system for managing a portal server includes:

a first server that stores association information about subscriber identification information and a plurality of portal servers; and

a second server that detects subscriber identification information of a subscriber terminal from an access request received from the subscriber terminal, and allocates an accommodation destination of the access request to one of the plurality of portal servers, based on the subscriber identification information and the association information of the first server.

A program recording medium that records a program for causing a computer to function as a device for managing a portal server according to one aspect of the present invention, the program recording medium recording a program that achieves, in the computer:

a function of detecting subscriber identification information of a subscriber terminal from an access request received from the subscriber terminal; and

a function of allocating an accommodation destination of the access request to one of a plurality of portal servers, based on the subscriber identification information.

### Advantageous Effects of Invention

According to one aspect of the present invention, an increase in the number of portal servers may be achieved without a burden on a subscriber while flexibility in an aspect of network operation is maintained.

### BRIEF DESCRIPTION OF DRAWINGS

FIG. 1 is a network diagram illustrating one example of a functional configuration of a network including a management system according to one example embodiment of the present invention.

FIG. 2 is a block diagram illustrating a configuration example of a centralized management server in a management system according to a first specific example of the present invention.

FIG. 3 is a block diagram illustrating a configuration example of a subscriber information management server in the first specific example.

FIG. 4 is a block diagram illustrating a configuration example of a Web portal server in the first specific example.

FIG. 5 is a sequence diagram illustrating a first example of a management method according to the first specific example.

FIG. 6 is a sequence diagram illustrating a second example of the management method according to the first specific example.

FIG. 7 is a block diagram illustrating a configuration example of an IPFE in a management system according to a second specific example of the present invention.

FIG. 8 is a sequence diagram illustrating a first example of a management method according to the second specific example.

FIG. 9 is a sequence diagram illustrating a second example of the management method according to the second specific example.

FIG. 10 is a block diagram illustrating a configuration example of a centralized management server in a management system according to a third specific example of the present invention.

FIG. 11 is a block diagram illustrating a configuration example of a management device according to a fourth specific example of the present invention.

FIG. 12 is a diagram illustrating one example of a hardware configuration of a computer device that achieves the server according to each example embodiment or specific example.

### EXAMPLE EMBODIMENT

### Overview of Example Embodiment

According to one example embodiment of the present invention, a management device that aggregates access requests to a portal server is provided, and the management device controls the access requests in such a way as to guide the access request to an appropriate portal server among a plurality of portal servers. With this management device, a load may be distributed among the plurality of portal servers, and flexibility in an aspect of operating a virtual system may be maintained. Further, even when a system change for handling an increase in the number of subscribers, such as addition or change of a portal server, is made, the system change may be concealed from a subscriber and a maintenance operator. In other words, a subscriber and a maintenance operator may perform operation similarly to a case of a single portal server. In this way, a burden of a setting change on a subscriber may be reduced, and searching when a maintenance operation is performed for each subscriber may increase in speed.

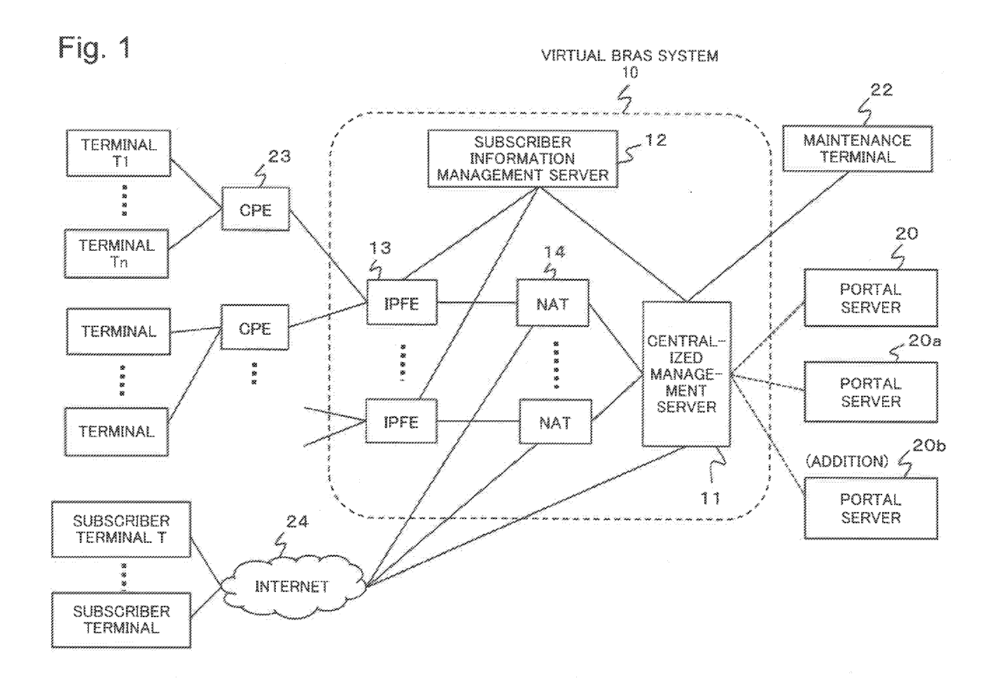

Hereinafter, a virtual broadband remote access server (BRAS) system including a function in which a BRAS used in a fixed access network is virtualized is taken as one example. The network function virtualization has advantages for a communication carrier such as a reduction in capital expenditure (CAPEX) and operating expense (OPEX), suppression of installation space and power consumption of equipment, and ease of adopting to a new service. The network function virtualization also has advantages for a subscriber such as ease of a support for an upgrade and the like because a dynamic host configuration protocol (DHCP) function provided in a broadband router in premises of a subscriber, a network address translation (NAT) function, and a Web portal function used for setting processing of each function and displaying a state are aggregated on a server in a network of a communication carrier from customer premises equipment, and thus the customer premises equipment (CPE) is simplified. Therefore, access requests may be distributed to a plurality of portal servers while the advantages of the virtualization network may be maintained by applying the present example embodiment to the virtual BRAS system. Hereinafter, the present example embodiment is described with reference to FIG. 1.

As illustrated in FIG. 1, a virtual BRAS system 10 according to the present example embodiment is disposed between a Web portal server group including a plurality of portal servers 20, 20a, . . . and each subscriber terminal. The virtual BRAS system 10 includes a centralized management server 11 including a function of aggregating access requests from a terminal and distributing the access requests to appropriate portal servers, a subscriber information management server 12 that manages connection authentication and subscriber information, a plurality of Internet protocol front ends (IPFEs) 13 that accommodate a plurality of CPEs and serve as entrances of the virtual BRAS system 10, and a plurality of NATs 14 that perform address translation during communication from the subscriber terminal to the Internet 24.

A maintenance terminal 22 is connected to the centralized management server 11, and makes an access request to a portal server according to an investigation request from each subscriber. Each of the CPEs 23 accommodates a plurality of subscriber premises terminals and is connected to the IPFE 13 of the virtual BRAS system 10. Further, the centralized management server 11 is connected to the Internet 24, and may also aggregate access requests via the Internet and distribute the access requests to appropriate portal servers.

Information that specifies an accommodation destination portal server associated with subscriber information is stored in the subscriber information management server 12. Therefore, the function of distributing an access request from a terminal to an appropriate portal server may guide an access request from each subscriber to each accommodation destination portal server by referring to the subscriber information management server 12. Such an access request may be guided by, for example, notifying a terminal of a redirection destination.

The function of distributing an access request from a terminal to an appropriate portal server may be provided in a network entity located before the portal server group. The function may be provided in, for example, at least one of the centralized management server 11 and the IPFEs 13 in the virtual BRAS system 10.

As described later, according to a first specific example of the present invention, the centralized management server 11 is equipped with the distribution function. Therefore, the centralized management server 11 may distribute an access request from the subscriber premises terminal through a fixed access network, an access request from the maintenance terminal 22, and an access request from the subscriber terminal through the Internet 24 to appropriate portal servers.

Further, according to a second specific example of the present invention, the IPFE 13 may also be provided with the distribution function. The IPFE 13 may distribute an access request from the subscriber premises terminal, and the centralized management server 11 may distribute an access request from the maintenance terminal 22 and an access request from the subscriber terminal through the Internet 24 to appropriate portal servers.

As described above, according to the present example embodiment, even when the number of subscribers to be accommodated increases and the plurality of portal servers are needed, a subscriber and a maintenance operator of a communication carrier may operate the plurality of portal servers without being conscious of a change of the virtual BRAS system. Further, a load may be distributed among the plurality of portal servers, and flexibility in an aspect of operating the virtual system may be maintained by distributing an access request. Hereinafter, the first and second specific examples of the present invention are described in detail with reference to drawings.

### 1. First Specific Example

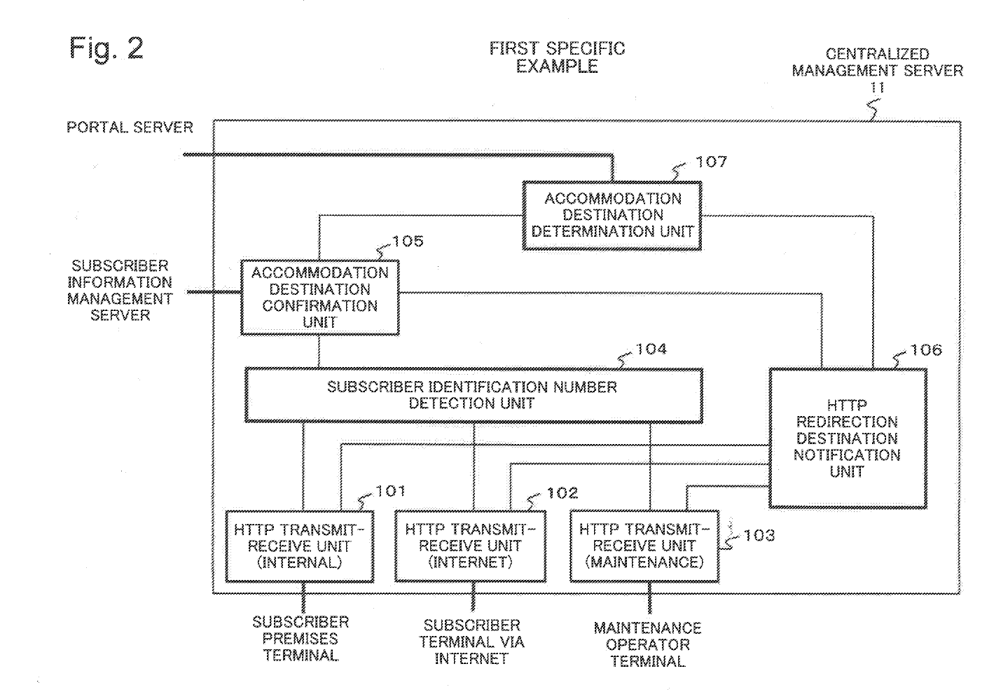

According to the first specific example of the present invention, the centralized management server 11 in the system illustrated in FIG. 1 is provided with the function of distributing an access request from the subscriber premises terminal, an access requests from the maintenance terminal 22, and an access request from the subscriber terminal through the Internet 24 to appropriate portal servers. Hereinafter, configurations and functions of the centralized management server 11, the subscriber information management server 12, and the portal server 20 are described with reference to FIGS. 2 to 4.

1.1 Centralized Management Server

As exemplified in FIG. 2, the centralized management server 11 includes HTTP transmit-receive units 101 to 103 as three different network interfaces and a subscriber identification number detection unit 104. The HTTP transmit-receive unit 101 is used for communication (Internal) when a subscriber makes access from premises through the virtual BRAS system 10. The HTTP transmit-receive unit 102 is used for communication (Internet) when a subscriber makes access through the Internet 24. The HTTP transmit-receive unit 103 is used for communication (maintenance) when a communication carrier makes access for a maintenance operation for a subscriber. The subscriber identification number detection unit 104 detects a subscriber identification number from an access request received by each of the HTTP transmit-receive units.

When the subscriber identification number detection unit 104 receives an access request through the HTTP transmit-receive unit, the subscriber identification number detection unit 104 detects a subscriber identification number of a transmission source terminal of the access request and outputs the subscriber identification number to an accommodation destination confirmation unit 105. The accommodation destination confirmation unit 105 makes an inquiry to the subscriber information management server 12 about a URL of an accommodation destination portal server associated with the subscriber identification number, acquires an accommodation destination URL in response to the inquiry, and outputs the accommodation destination URL to an HTTP redirection destination notification unit 106.

When an accommodation destination URL is not acquired from the subscriber information management server 12, the accommodation destination confirmation unit 105 instructs an accommodation destination determination unit 107 to determine an accommodation destination associated with the subscriber identification number. The accommodation destination determination unit 107 selects one from the portal servers 20, 20a, and 20b subordinate to the accommodation destination determination unit 107 according to a predetermined selection reference, and outputs an URL thereof as an accommodation destination URL to each of the accommodation destination confirmation unit 105 and the HTTP redirection destination notification unit 106. The accommodation destination confirmation unit 105 that received the accommodation destination URL registers the accommodation destination URL and the associated subscriber identification number in the subscriber information management server 12. Note that, the selection reference of a portal server being an accommodation destination by the accommodation destination determination unit 107 may be set from, for example, a viewpoint of load distribution.

The HTTP redirection destination notification unit 106 generates an HTTP redirection destination notification by using the accommodation destination URL received from the accommodation destination confirmation unit 105 or the accommodation destination determination unit 107, and transmits the HTTP redirection destination notification to a subscriber terminal that has made an access request. When the subscriber terminal that has made the access request receives the HTTP redirection destination notification, the subscriber terminal makes access to a portal server by using the accommodation destination URL. Note that, the function of the subscriber information management server 12 may be provided in the centralized management server 11.

Note that, a block configuration illustrated in FIG. 2 illustrates a functional configuration of the centralized management server 11, and each function may be achieved by hardware or software. For example, an identical functional configuration may be achieved by executing a program stored in a memory, which is not illustrated, on a central processing unit (CPU) of the centralized management server 11. Alternatively, the centralized management server 11 may also be achieved as a virtual network function on a virtual machine operated by a general-purpose server.

1.2 Subscriber Information Management Server

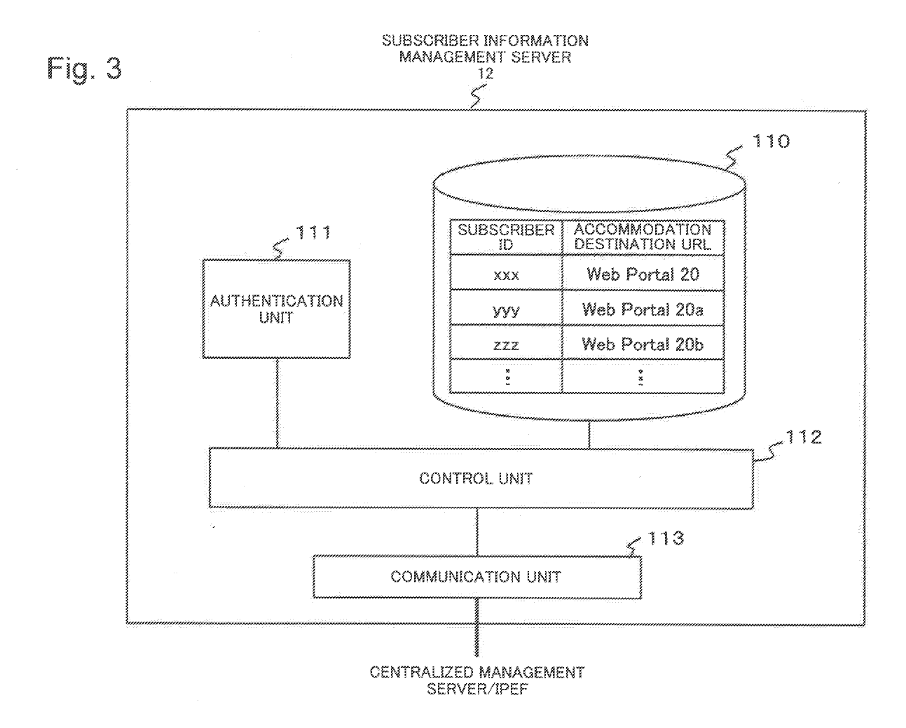

As exemplified in FIG. 3, the subscriber information management server 12 includes a database 110 that stores subscriber information and an authentication unit 111, and communicates with the centralized management server 11 or the IPEF 13 through a communication unit 113 under control of a control unit 112. A subscriber identification number and a URL of a portal server that accommodates the subscriber terminal are stored in the database 110 in association with each other. When the centralized management server 11 makes an accommodation destination acquisition request, the control unit 112 searches the database 110 with the subscriber identification number as a key, reads an associated accommodation destination URL, and returns the accommodation destination URL to the centralized management server 11.

Further, when the centralized management server 11 makes a request to register a new entry (a pair of a subscriber identification number and a determined accommodation destination URL), the control unit 112 adds the new entry to the database 110.

For example, it is assumed that the new portal server 20b is added to the portal server group, and a subscriber accommodated in another portal server is moved to the new portal server 20b. In this case, an entry of the subscriber accommodated in the other portal server may be deleted, and an entry associated with a new accommodation destination URL may be registered in the database 110. In this way, by performing simple control such as updating, registration, or deletion of an entry on the database 110, a subscriber and a maintenance operator may make a system change such as a change of a portal server group, and addition or deletion of a portal server without being conscious.

1.3 Web Portal Server

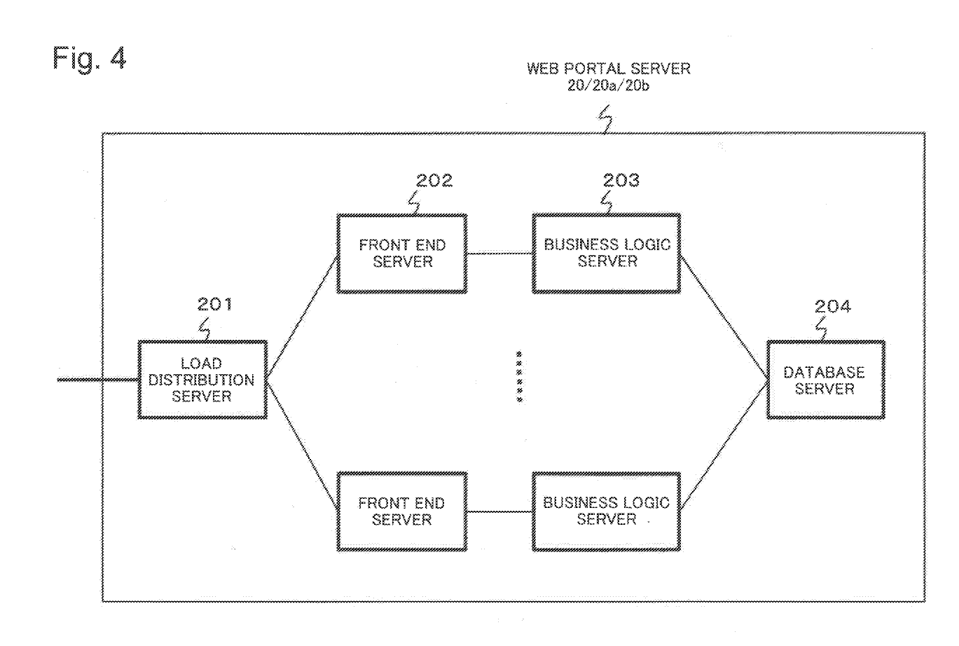

As exemplified in FIG. 4, the Web portal server (20/20a/20b) includes a load distribution server 201 serving as a receiving port of an HTTP packet, a plurality of pairs of servers (front end servers 202 and business logic servers 203), and a database server 204. The front end server 202 transfers a received HTTP packet to the business logic server 203 and controls screen generation and screen transition. The business logic server 203 executes various requests received from the front end server 202. The database server 204 stores information executed or updated by the business logic server 203.

The business logic server 203 has the largest processing load in the Web portal server. The front end server 202 has a lower processing load because the front end server 202 is limited to processing of transferring a packet between the business logic server 203 being a pair of the front end server 202 and the load distribution server 201 and screen generation of a processing result.

When the number of subscribers increases and a load on the business logic server 203 increases, a new pair of the front end server 202 and the business logic server 203 is added in order to handle the situation as illustrated in FIG. 4. When the addition of such a pair of servers reaches an upper limit, addition of a Web portal server itself is needed in order to accommodate further subscribers. As already described above, an existing subscriber is moved to another portal server for load distribution, and a new subscriber is accommodated in an added portal server in the configuration in which the plurality of Web portal servers are installed, and such changes on a system side are concealed from a subscriber/maintenance operator side by the access management according to the present specific example. Hereinafter, the access management according to the present specific example in the configuration of the plurality of portal servers is described in detail.

1.4 Operation

Internal Access

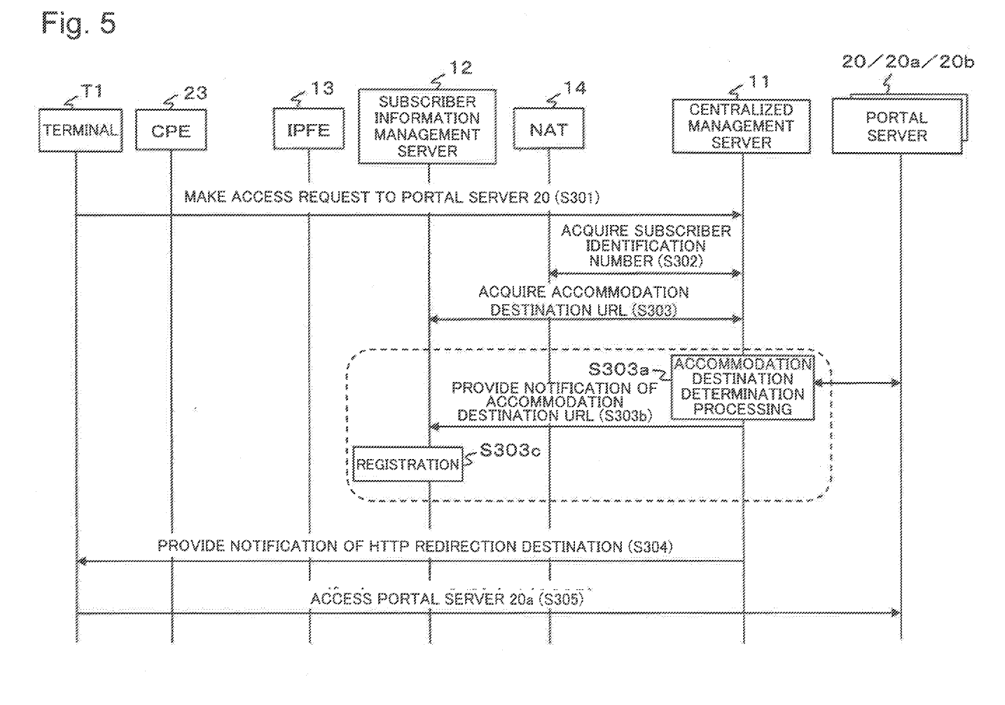

With reference to FIG. 5, access management when the terminal T1 makes an access request to the Web portal server through the virtual BRAS system 10 in the system in which the plurality of portal servers are set is described.

In FIG. 5, a subscriber designates a URL (for example, the portal server 20) associated with the centralized management server 11 and makes an access request by an HTTP request on a Web browser of the terminal T1 (operation S301). When the centralized management server 11 receives the HTTP request, the centralized management server 11 acquires a subscriber identification number from the NAT 14, based on a transmission source IP address of the HTTP request (operation S302).

Subsequently, the centralized management server 11 makes an acquisition request for an accommodation destination URL associated with the acquired subscriber identification number to the subscriber information management server 12, and acquires a URL of an accommodation destination portal server of the subscriber from the subscriber information management server 12 (operation S303). As illustrated in FIG. 3, when the control unit 112 of the subscriber information management server 12 receives an acquisition request for an accommodation destination URL including a subscriber identification number, the control unit 112 searches the database 110 with the subscriber identification number as a key. When the associated accommodation destination URL is found, the control unit 112 returns the accommodation destination URL to the centralized management server 11 that made the request for the accommodation destination URL, through the communication unit 113. When the associated accommodation destination URL is not registered yet, the control unit 112 returns a response indicating that the accommodation destination URL is not registered yet.

The case where the associated accommodation destination URL is not registered yet represents a case where a subscriber makes a connection request to a portal server for the first time. When the associated accommodation destination URL is not acquired, the centralized management server 11 performs the processing of determining an accommodation destination portal server from the portal servers (the three portal servers 20, 20a, and 20b in this example) subordinate to the centralized management server 11 (operation S303a), and notifies the subscriber information management server 12 of the determined accommodation destination URL (operation S303b), as already described above. The subscriber information management server 12 registers the determined accommodation destination URL in association with the subscriber identification number in the database 110 (operation S303c).

When the accommodation destination URL is acquired in this way, the centralized management server 11 notifies the terminal T1 by HTTP redirection that the terminal T1 is to be connected to a portal server (for example, the portal server 20a) being an accommodation destination (operation S304). In this way, the terminal T1 that received the HTTP redirection executes access to the portal server 20a to which the terminal T1 is redirected instead of the portal server 20 associated at first (operation S305).

Internet/Maintenance Access

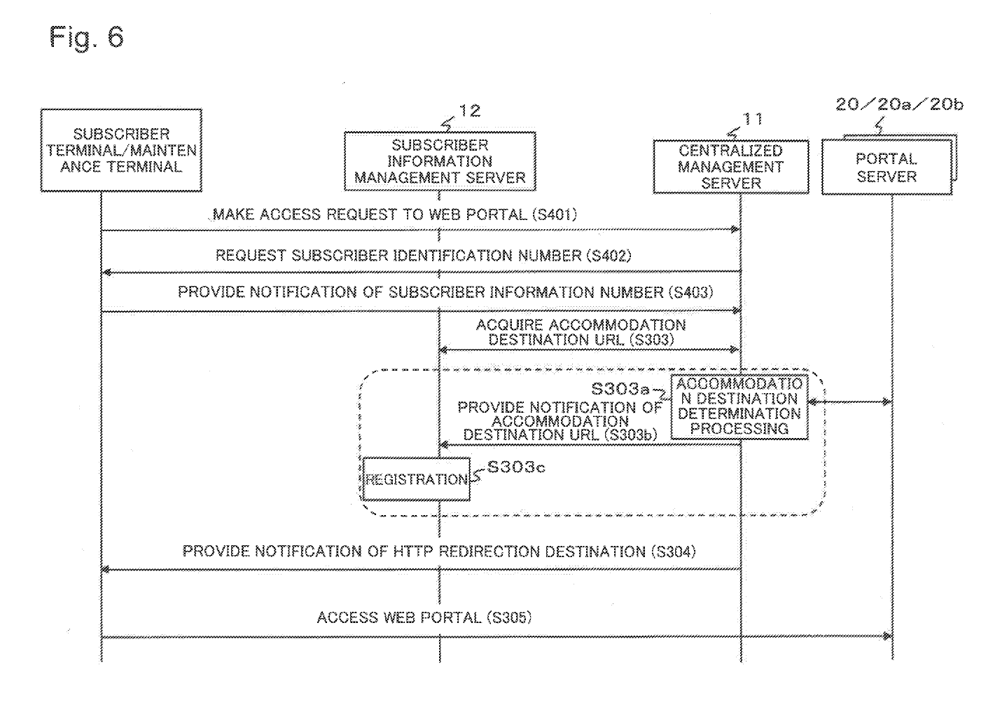

With reference to FIG. 6, access (Internet access) via the Internet or access (maintenance access) for a maintenance operation made by a communication carrier at a request from a subscriber is described. Note that, the Internet access and the maintenance access only have different networks to which a terminal as an access source belongs, and each has a sequence similar to each other. Therefore, a case of the Internet access is described as one example.

In FIG. 6, the subscriber terminal makes an access request to a URL associated with the centralized management server 11 via the Internet 24 (operation S401). The centralized management server 11 performs reception processing in the HTTP transmit-receive unit 102, and requests the subscriber terminal for a subscriber identification number (operation S402). In response, the subscriber terminal notifies the centralized management server 11 of the subscriber identification number (operation S403).

The centralized management server 11 makes an acquisition request for an accommodation destination URL associated with the acquired subscriber identification number to the subscriber information management server 12, and acquires a URL of an accommodation destination portal server of the subscriber from the subscriber information management server 12 (operation S303). Hereinafter, as described in FIG. 5, the processing when the accommodation destination URL is not acquired (operations S303a to S303c), the notification of the HTTP redirection destination (operation S304), and the access from the subscriber terminal (operation S305) are successively performed.

1.5 Effect

As described above, according to the present specific example, even in the environment in which the plurality of Web portal servers are installed, the virtual BRAS system 10 allows a subscriber of a terminal being an access source to make access without being conscious of the plurality of portal servers in which the subscriber is accommodated. As a result, convenience for the subscriber or a maintenance operator is improved. Further, although an access destination presented when a subscriber makes a contract is common to all users, a communication carrier may flexibly operate without setting a fixed accommodation destination portal server. Thus, flexibility in an aspect of operation management is improved, which results in an advantage leading to cost reduction.

### 2. Second Specific Example

The centralized management server 11 performs management of distributing an access request in the first specific example described above, but one aspect of the present invention is not limited to this. A processing load of the centralized management server 11 may also be shared between the centralized management server 11 and another entity in the virtual BRAS system 10.

The access (Internal access) from subscriber premises accounts for most of the access to the portal server described above, and the Internet access and the maintenance access are limited to an emergency and the like. Therefore, when the number of accommodated subscribers in the virtual BRAS system 10 increases, it is conceivable that the number of Internal access mainly increases, and a processing load of the centralized management server 11 rapidly increases.

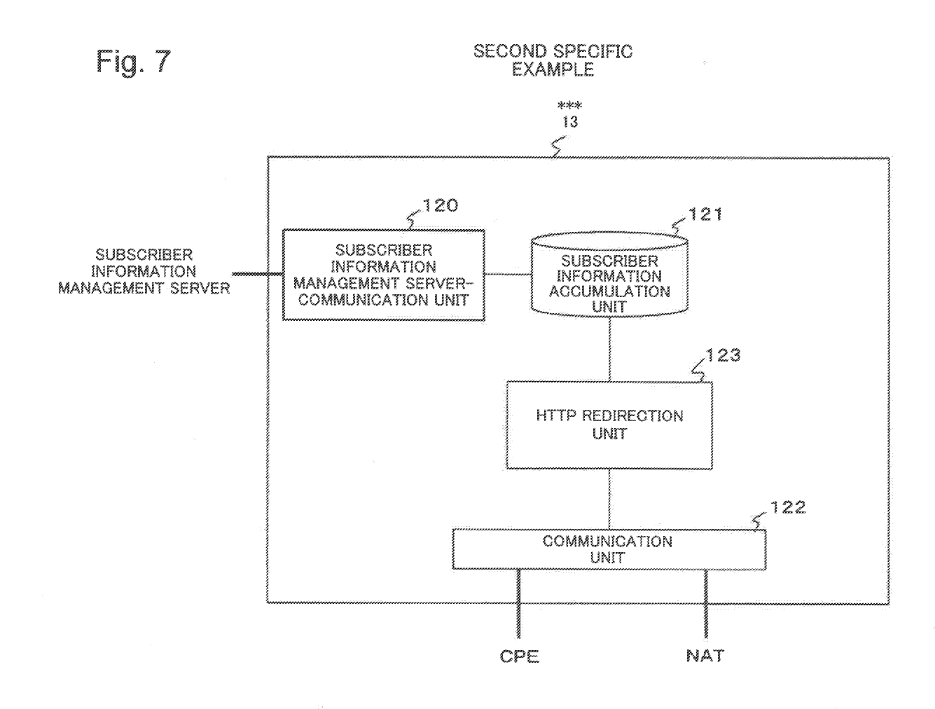

Thus, the IPFE 13 in cooperation with the subscriber information management server 12 at the entrance of the virtual BRAS system 10 is provided with the HTTP redirection function, and load distribution is achieved in the second specific example of the present invention. In other words, an investment in the centralized management server 11 is reduced by sharing a part of the access management with the IPFE 13, which leads to improvement in CAPEX. Hereinafter, the present specific example is described in detail with reference to FIGS. 7 to 9.

As exemplified in FIG. 7, the IPFE 13 according to the present specific example includes a subscriber information management server-communication unit 120 that communicates with the subscriber information management server 12, and accumulates subscriber information acquired from the subscriber information management server 12 through the subscriber information management server-communication unit 120 in a subscriber information accumulation unit 121. The subscriber information includes at least an entry including a subscriber identification number and an accommodation destination URL of the subscriber identification number exemplified in FIG. 3.

The IPFE 13 further includes a communication unit 122 being an interface that communicates with a subscriber premises terminal and the centralized management server 11 and an HTTP redirection unit 123. The HTTP redirection unit 123 determines whether or not a URL intended for the centralized management server 11 is designated in an HTTP packet received from the subscriber terminal. When the URL is designated, the HTTP redirection unit 123 acquires an associated accommodation destination URL from the subscriber information accumulation unit 121, and notifies the subscriber terminal of the accommodation destination URL being an HTTP redirection destination.

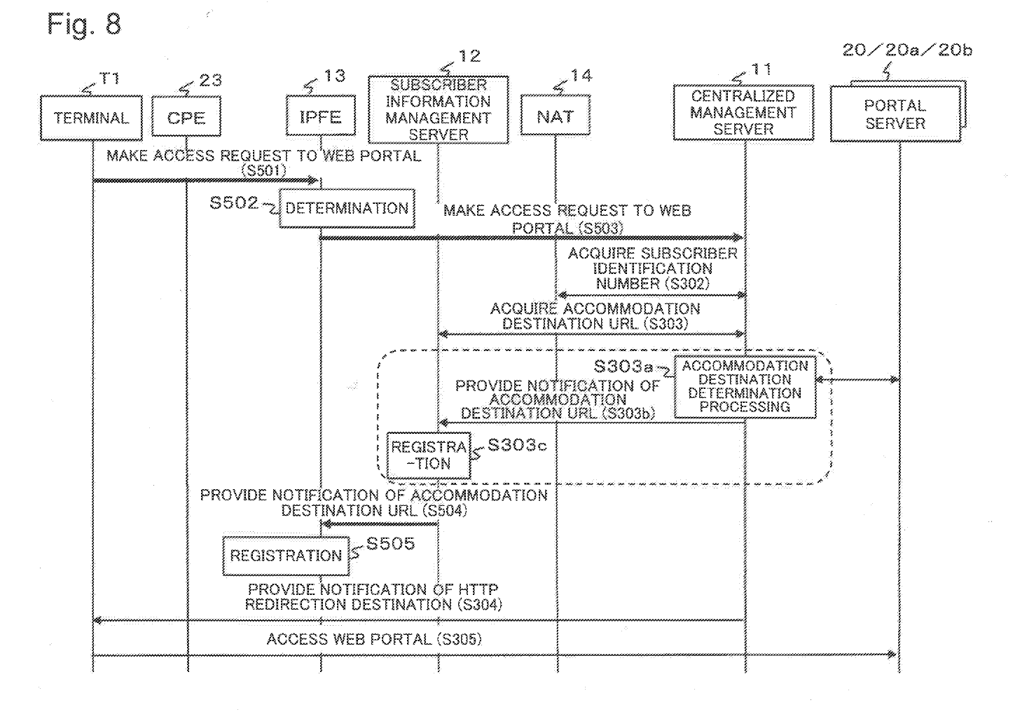

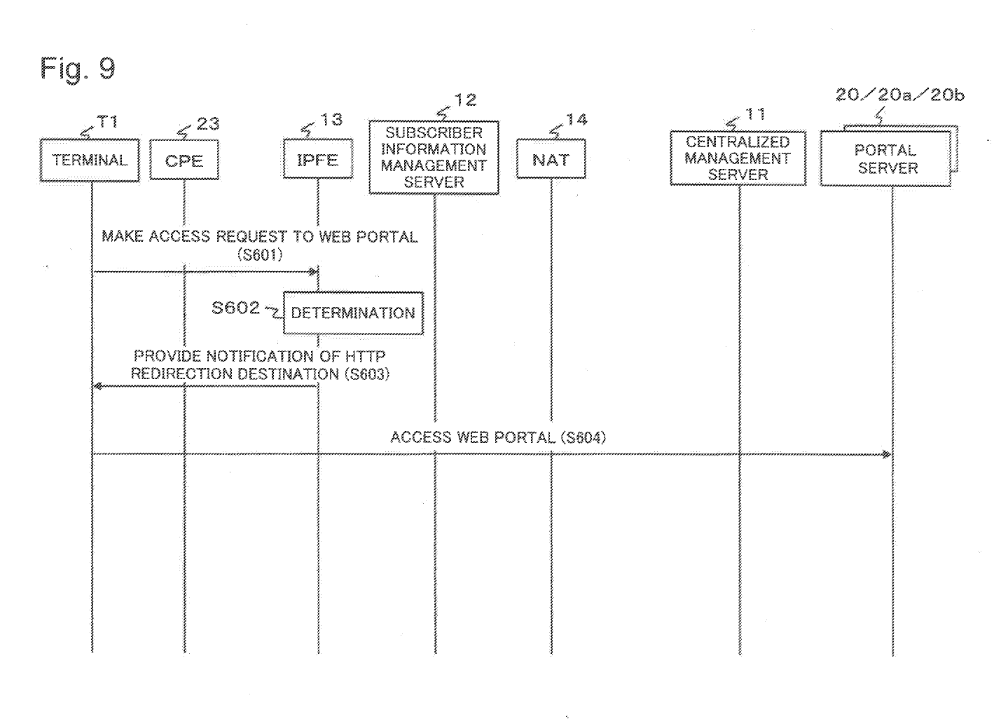

Hereinafter, the Internal access (for example, when access is made from a subscriber premises terminal to a portal server for the first time) when an accommodation destination URL is not accumulated in the IPFE 13 is described with reference to FIG. 8, and the Internal access on and after the second time is described with reference to FIG. 9.

In FIG. 8, a subscriber designates a URL (for example, the portal server 20) associated with the centralized management server 11 and makes an access request by an HTTP request on a Web browser of the terminal T1 (operation S501). When the HTTP redirection unit 123 of the IPFE 13 receives the HTTP request from the terminal T1, the HTTP redirection unit 123 determines whether or not the received packet is intended for the centralized management server 11 and the HTTP redirection unit 123 may perform redirection processing on the received packet (operation S502). More specifically, when the received packet is intended for the centralized management server 11, the HTTP redirection unit 123 searches the subscriber information accumulation unit 121 with, as a key, a subscriber identification number of the terminal T1 being a transmission source of the HTTP request, and determines presence or absence of an associated accommodation destination URL. The access is made for the first time herein, and thus the accommodation destination URL is not registered yet in the subscriber information accumulation unit 121. Therefore, the HTTP redirection unit 123 transfers the HTTP request to the centralized management server 11 (operation S503).

When the centralized management server 11 receives the HTTP request, the centralized management server 11 acquires a subscriber identification number from the NAT 14, based on a transmission source IP address of the HTTP request (operation S302). Subsequently, as already described above, the centralized management server 11 makes an acquisition request for an accommodation destination URL associated with the acquired subscriber identification number to the subscriber information management server 12, and acquires a URL of an accommodation destination portal server of the subscriber from the subscriber information management server 12 (operation S303). When the accommodation destination URL including the subscriber identification number is already registered in the subscriber information management server 12, the accommodation destination URL is returned to the centralized management server 11 that made the request for the accommodation destination URL. When the associated accommodation destination URL is not registered yet, the centralized management server 11 determines an accommodation destination portal server from the portal servers subordinate to the centralized management server 11 (operation S303a), and notifies the subscriber information management server 12 of the determined accommodation destination URL (operation S303b), as already described above. The subscriber information management server 12 registers the determined accommodation destination URL in association with the subscriber identification number (operation S303c).

The accommodation destination URL that is already registered or is newly registered in the subscriber information management server 12 is notified to the IPFE 13 (operation S504), and is registered in association with the subscriber identification number in the subscriber information accumulation unit 121 of the IPFE 13 (operation S505).

When the accommodation destination URL is acquired in this way, the centralized management server 11 notifies the terminal T1 by HTTP redirection that the terminal T1 is to be connected to a portal server as an accommodation destination (operation S304), and the terminal T1 that received the HTTP redirection executes access to the portal server to which the terminal T1 is redirected (operation S305).

In FIG. 9, it is assumed that an accommodation destination URL associated with a subscriber identification number is already registered in the subscriber information accumulation unit 121 of the IPFE 13. When a subscriber designates a URL associated with the centralized management server 11 and makes an access request on a Web browser of the terminal T1 (operation S601), the IPFE 13 determines whether or not the received packet is intended for the centralized management server 11 and the IPFE 13 may perform redirection processing on the received packet (operation S602). When the received packet is intended for the centralized management server 11, the IPFE 13 searches the subscriber identification number of the received packet for the accommodation destination URL. Since the accommodation destination URL is already registered herein, the HTTP redirection unit 123 provides a notification including the accommodation destination URL as an HTTP redirection destination to the terminal T1 that made the request for the notification (operation S603). The terminal T1 that received the HTTP redirection executes access to the portal server to which the terminal T1 is redirected (operation S604).

As described above, according to the second specific example of the present invention, an effect similar to that in the first specific example may be obtained, and, furthermore, the redirection processing is performed on the subscriber premises terminal in which the Internal access is executed in the IPFE 13 before the centralized management server 11 on and after the second time, and the HTTP request is returned to the terminal side. Therefore, a processing load on the centralized management server 11 may be greatly reduced.

### 3. Third Specific Example

According to a third specific example of the present invention, a spare server is prepared in a portal server group, and a centralized management server may cause the spare server to function as an additional portal server depending on a load situation and the like of the portal server group. In this way, addition of a portal server may be performed automatically without human labor.

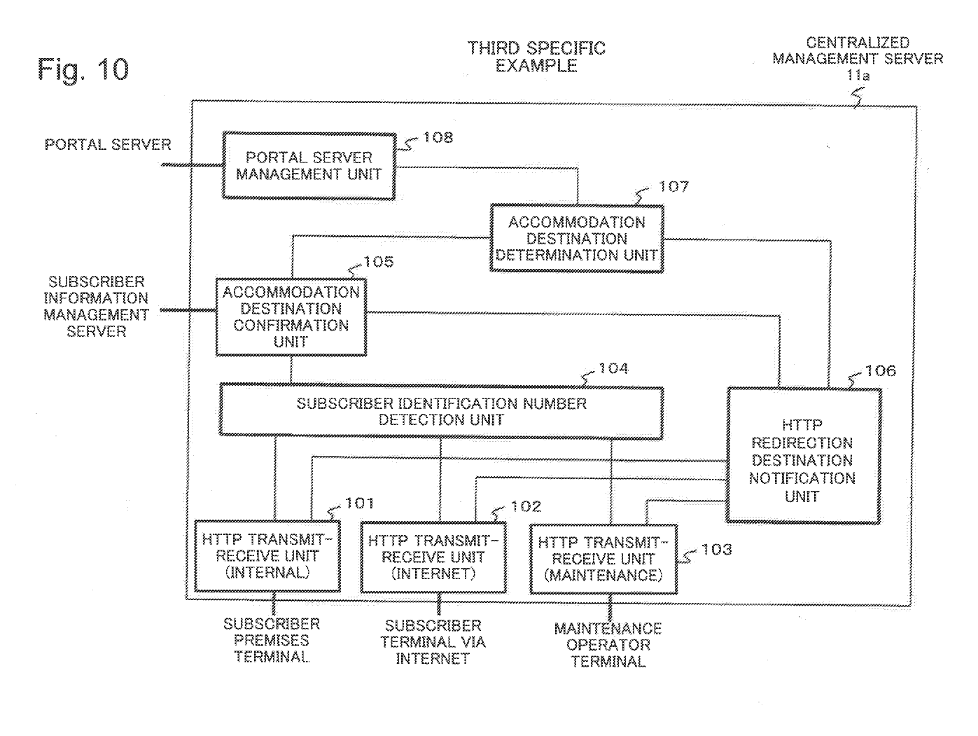

As exemplified in FIG. 10, a centralized management server 11a according to the third specific example is different from the centralized management server 11 illustrated in FIG. 2 in that a portal server management unit 108 that monitors a load situation and a resource use situation of a portal server group and performs automatic addition of a spare server is provided. The other configurations and functions are similar to those in FIG. 2, and thus the same block is provided with the same reference numeral and description thereof is omitted.

For example, it is assumed that the portal servers 20 and 20a in FIG. 1 operate as current portal servers, and the portal server 20b stands by as a spare server. The portal server management unit 108 monitors a load situation and a resource use situation of a current portal server group, and activates the portal server (spare server) 20b as an additional portal server when a load increases due to an increase in the number of subscribers and the like and the portal server management unit 108 determines that a new portal server is needed. The access management using the portal server group added in this way may also be performed in such a manner described in the above-mentioned first and second specific examples.

### 4. Fourth Specific Example

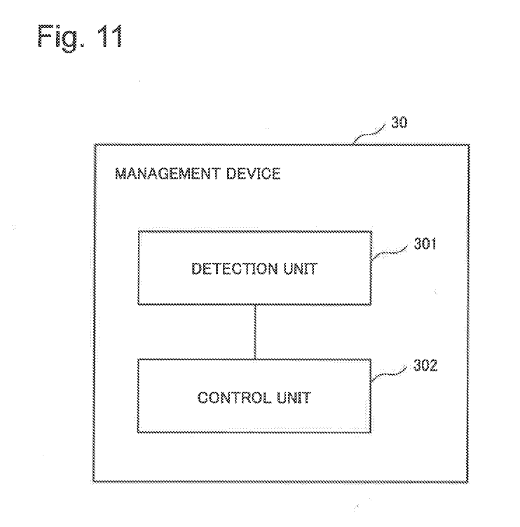

FIG. 11 is a block diagram illustrating a configuration example of a management device 30 according to a fourth specific example of the present invention. As illustrated in FIG. 11, the management device 30 includes a detection unit 301 and a control unit 302. The management device 30 is a device for managing a portal server.

The detection unit 301 detects subscriber identification information of a subscriber terminal from an access request received from the subscriber terminal. The control unit 302 allocates an accommodation destination of the access request to one of a plurality of portal servers, based on the subscriber identification information.

Note that, the detection unit 301 and the control unit 302 are respectively achieved by the subscriber identification number detection unit 104, and the accommodation destination confirmation unit 105 and the accommodation destination determination unit 107 described in the above-mentioned example embodiment as one example.

According to the fourth specific example, an increase in the number of portal servers may be achieved without a burden on a subscriber while flexibility in an aspect of operating a network is maintained by adopting the above-mentioned configuration.

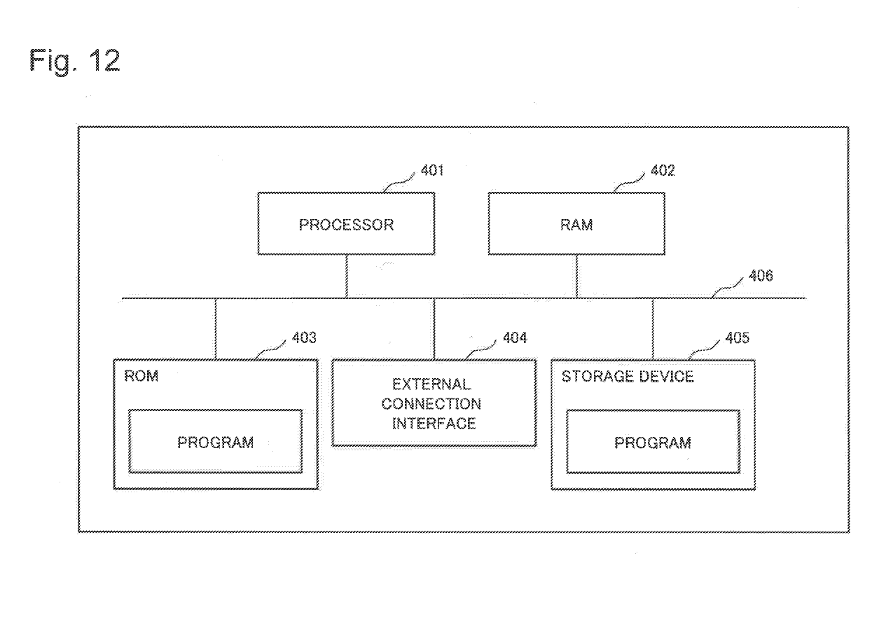

Note that, each unit of the above-described server is achieved by a hardware resource exemplified in FIG. 12. In other words, the configuration illustrated in FIG. 12 includes a processor 401, a random access memory (RAM) 402, a read only memory (ROM) 403, an external connection interface 404, a storage device 405, and a bus 406 connecting each component.

In each example embodiment described above, a case where a computer program that may achieve the above-described function is supplied to a server, and the function is then achieved by reading and executing the computer program in the RAM 402 by the processor 401 is described as one example executed by the processor 401 illustrated in FIG. 12. However, a part or the whole of the function illustrated in each block of the server may be achieved as hardware.

The supplied computer program may be stored in a readable/writable memory (temporary storage medium) or a computer-readable storage device such as a hard disk device. Then, in such a case, it may be understood that one aspect of the present invention includes a storage medium that stores a code representing the computer program or the computer program.

### 5. Supplementary Note

A part or the whole of the above-described example embodiment may also be described as Supplementary Notes below, which is not limited thereto.

Supplementary Note 1

A management device for managing a portal server including:

a detection means for detecting subscriber identification information of a subscriber terminal from an access request received from the subscriber terminal; and

a control means for allocating an accommodation destination of the access request to one of a plurality of portal servers, based on the subscriber identification information.

Supplementary Note 2

The management device according to Supplementary Note 1, wherein

the control means determines one of the plurality of portal servers as an accommodation destination of the access request by referring to association information about subscriber identification information and an accommodation destination portal server.

Supplementary Note 3

The management device according to Supplementary Note 2, wherein

the association information is stored in a server capable of performing communication, and the association information is acquired from the server.

Supplementary Note 4

The management device according to any one of Supplementary Notes 1 to 3, wherein

the control means notifies the subscriber terminal of positional information about a portal server associated with the subscriber identification information as a redirection destination.

Supplementary Note 5

The management device according to any one of Supplementary Notes 1 to 4, wherein

the control means monitors a load situation of the plurality of portal servers, and allocates an accommodation destination of the access request to one of the plurality of portal servers, based on the load situation.

Supplementary Note 6

A virtual broadband remote access server (BRAS) system including

the management device according to any one of Supplementary Notes 1 to 5.

Supplementary Note 7

A server including

the management device according to any one of Supplementary Notes 1 to 5.

Supplementary Note 8

An Internet protocol front end (IPFE) including

the management device according to any one of Supplementary Notes 1 to 5.

Supplementary Note 9

A management method for managing a portal server including:

detecting, by a detection means, subscriber identification information of a subscriber terminal from an access request received from the subscriber terminal; and

allocating, by a control means, an accommodation destination of the access request to one of a plurality of portal servers, based on the subscriber identification information.

Supplementary Note 10

The management method according to Supplementary Note 9, wherein

the control means determines one of the plurality of portal servers as an accommodation destination of the access request by referring to association information about subscriber identification information and an accommodation destination portal server.

Supplementary Note 11

The management method according to Supplementary Note 10, wherein

the association information is stored in a server capable of performing communication, and the association information is acquired from the server.

Supplementary Note 12

The management method according to any one of Supplementary Notes 9 to 11, wherein

the control means monitors a load situation of the plurality of portal servers, and allocates an accommodation destination of the access request to one of the plurality of portal servers, based on the load situation.

Supplementary Note 13

The management method according to any one of Supplementary Notes 9 to 12, wherein

the control means notifies the subscriber terminal of positional information about a portal server associated with the subscriber identification information as a redirection destination.

Supplementary Note 14

A management system for managing a portal server including:

a first server that stores association information about subscriber identification information and a plurality of portal servers; and

a second server that detects subscriber identification information of a subscriber terminal from an access request received from the subscriber terminal, and allocates an accommodation destination of the access request to one of the plurality of portal servers, based on the subscriber identification information and the association information of the first server.

Supplementary Note 15

The management system according to Supplementary Note 14, wherein

the second server determines one of the plurality of portal servers as an accommodation destination of the access request by referring to the association information of the first server.

Supplementary Note 16

The management system according to Supplementary Note 14 or 15, wherein

the second server monitors a load situation of the plurality of portal servers, and allocates an accommodation destination of the access request to one of the plurality of portal servers, based on the load situation.

Supplementary Note 17

The management system according to any one of Supplementary Notes 14 to 16, wherein

the second server notifies the subscriber terminal of positional information about a portal server associated with the subscriber identification information as a redirection destination.

Supplementary Note 18

A virtual broadband remote access server (BRAS) system including the management system according to any one of Supplementary Notes 14 to 17 as a virtualized network function.

Supplementary Note 19

A program recording medium that records a program for causing a computer to function as a device for managing a portal server, the program recording medium recording a program that achieves, in the computer:

a function of detecting subscriber identification information of a subscriber terminal from an access request received from the subscriber terminal; and

a function of allocating an accommodation destination of the access request to one of a plurality of portal servers, based on the subscriber identification information.

One aspect of the present invention is described above with reference to the above-described example embodiment. However, one aspect of the present invention is not limited to the above-described example embodiment. In other words, various aspects apparent to those skilled in the art, such as various combination or selection of various disclosed elements mentioned above, may be applied to one aspect of the present invention within the scope of one aspect of the present invention.

This application is based upon and claims the benefit of priority from Japanese patent application No. 2016-162517, filed on Aug. 23, 2016, the disclosure of which is incorporated herein in its entirety by reference.

### INDUSTRIAL APPLICABILITY

One aspect of the present invention is applicable to a system that possesses a portal site.

### REFERENCE SIGNS LIST

10 Virtual BRAS system
11 Centralized management server
12 Subscriber information management server
13 IPFE
14 NAT
20, 20a, 20b Portal server
22 Maintenance terminal
23 CPE
24 Internet
101, 102, 103 HTTP transmit-receive unit
104 Subscriber identification number detection unit
105 Accommodation destination confirmation unit
106 HTTP redirection destination notification unit
107 Accommodation destination determination unit
108 Portal server management unit
110 Database
111 Authentication unit
112 Control unit
113 Communication unit
201 Load distribution server
202 Front end server
203 Business logic server
204 Database server

1. A management device for managing a portal server comprising:
at least one memory configured to store instructions; and
at least one processor configured to execute the instructions to:
detect subscriber identification information of a subscriber terminal from an access request received from the subscriber terminal; and
allocate an accommodation destination of the access request to one of a plurality of portal servers, based on the subscriber identification information.

2. The management device according to claim 1, wherein
the at least one processor further configured to execute the instructions to determine one of the plurality of portal servers as an accommodation destination of the access request by referring to association information about subscriber identification information and an accommodation destination portal server.

3. The management device according to claim 2, wherein
the association information is stored in a server capable of performing communication, and the association information is acquired from the server.

4. The management device according to claim 1, wherein
the at least one processor further configured to execute the instructions to notify the subscriber terminal of positional information about a portal server associated with the subscriber identification information as a redirection destination.

5. The management device according to claim 1, wherein
the at least one processor further configured to execute the instructions to:
monitor a load situation of the plurality of portal servers; and allocate an accommodation destination of the access request to one of the plurality of portal servers, based on the load situation.

6-8. (canceled)

9. A management method for managing a portal server comprising:
detecting subscriber identification information of a subscriber terminal from an access request received from the subscriber terminal; and
allocating an accommodation destination of the access request to one of a plurality of portal servers, based on the subscriber identification information.

10. The management method according to claim 9, further comprising
determining one of the plurality of portal servers as an accommodation destination of the access request by referring to association information about subscriber identification information and an accommodation destination portal server.

11. The management method according to claim 10, wherein
the association information is stored in a server capable of performing communication, and the association information is acquired from the server.

12. The management method according to claim 9, further comprising:
monitoring a load situation of the plurality of portal servers;
and allocating an accommodation destination of the access request to one of the plurality of portal servers, based on the load situation.

13. The management method according to claim 9, further comprising
notifying the subscriber terminal of positional information about a portal server associated with the subscriber identification information as a redirection destination.

14-18. (canceled)

19. A non-transitory computer-readable medium that records a program for causing a computer to function as a device for managing a portal server, the program recording medium recording a program that achieves, in the computer:
a function of detecting subscriber identification information of a subscriber terminal from an access request received from the subscriber terminal; and
a function of allocating an accommodation destination of the access request to one of a plurality of portal servers, based on the subscriber identification information.
